(19) United States
(12) Patent Application Publication
(10) Pub. No.: US 2025/0218307 A1
(43) Pub. Date: Jul. 3, 2025

(54) System and methods for an AI-powered personalized education platform and educational content generation

(71) Applicant: Karima Askour, Alexandria, VA (US)

(72) Inventors: Karima Askour, Alexandria, VA (US); Meriyem Kaf, Milton (CA)

(73) Assignee: Karima Askour, Alexandria, VA (US)

(21) Appl. No.: 18/483,576

(22) Filed: Oct. 10, 2023

(51) Int. Cl. G09B 7/02; G06F 40/279

(52) U.S. Cl. CPC G09B 7/02; G06F 40/279

(57) ABSTRACT

An AI-based system generates personalized educational content tailored to individual students' abilities and needs. The platform analyzes academic standards, curriculum guidelines, and student data including IEP status using natural language processing to build customized profiles. Large language models (LLMs) including GPTs, BERT, and custom models as well as generative adversarial networks (GANs), diffusion models, and other AI algorithms are leveraged to dynamically generate lessons, assignments, recommendations, visual aids, and other educational content adapted for each learner. The system stores output in JSON format for further transformation. Educators can review auto-generated content, provide guiding prompts, and collaborate via social features. Administrative controls enable customization across districts and schools. By leveraging AI to automate personalized content creation, the system reduces teacher workload while improving educational outcomes.

### PRIOR ART

A review of existing literature and patents reveals relevant systems and methods that utilize artificial intelligence for various educational and compliance-related purposes. Specifically:

US20230208869 A1 titled “Generative artificial intelligence method and system configured to provide outputs for company compliance” filed by Akitra Inc. This patent application describes a system that leverages artificial intelligence for company compliance. Key features include:

An AI-based engine module coupled to a data source containing policies, evidence, controls, and other compliance-related information.

A mechanism to process queries and produce results which can be further refined using a generative AI process.

A risk module to manage company-associated risks.

A trust center system for creating visibility of compliance management.

US20230215282 A1 titled “Generative artificial intelligence learning method and system for an on-line course” filed by Amesite Inc. The described system focuses on real-time knowledge of current events and the creation of learning content. Distinctive elements encompass:

An AI processing engine coupled to a network of computers and an information storage system.

A learning content robot linked to the AI processing engine, which employs natural language processing to select and transfer documents based on their relevance to a learning management system.

The use of vector spaces to evaluate the importance and relevance of documents.

Robots are designed to curate, assess, answer, and accredit learning experiences.

While the aforementioned patents demonstrate the utility of artificial intelligence in education and compliance, the present invention distinguishes itself by specifically targeting personalized education. It emphasizes the creation of a highly adaptable and interactive learning environment tailored to individual student needs by leveraging advanced AI models such as Large Language Models (LLMs), GANs, and Diffusion Models. The inventive system also introduces unique features like smart analysis of educational standards, dynamic content generation, IEP analysis systems, and educator collaboration platforms, which are not explicitly addressed in the prior art.

### BACKGROUND OF THE INVENTION

Personalized education is critical for student success but difficult to implement on a scale. Crafting individualized materials is challenging and time-consuming for educators, contributing to teacher burnout. This invention leverages the most recent AI advances, such as: Large Language Models (LLMs), GANS, Diffusion Models, to automate personalized content generation, providing tailored instruction while alleviating educator workload. All these goals are achieved through the invention of the EZDucate platform which creatively combine different type of AI models and algorithms to empower teachers to generate customized content.

### SUMMARY OF THE INVENTION

The invention is a web and mobile application called EZDucate platform, developed by EZDucate LLC, a Virginia based company. EZDucate is composed of 3 sub modules, EZDucate Flashcards, EZDucate Language and Arts, and EZDucate Mathematics. The terms EZDucate, EZDucate platform, the invention will be used interchangeably to refer to the invention.

EZDucate platfom share a core component which is the object of this patent application as the systems and processes used are shared across the different EZDucate modules.

The invention is a web and mobile platform, and the underlying background processes that can be hosted in physical servers or with cloud providers, that uses different AI models, to create a highly customizable, interactive learning environment adapted to each student's needs and abilities. Key components include:

A smart analysis engine that ingests standards, curriculum guidelines, and student data including IEPs to build customized student profiles. The standards are based on Country, State/Region, District/County, School district, school and based on regional differences throughout the world.

A content generator using natural language processing (NLP), large language models (LLMs), Text to image, and Text to Video AI models, and other creative engines to dynamically produce personalized lessons, assignments, visual aids, videos, etc. based on student profiles.

Smart recommendation and IEP analysis systems that suggest interventions and modifications leveraging AI.

Teacher tools to review, edit, guide, and share auto-generated content via textual prompts. The teachers can share prompts and workflows as buttons or URLs.

Administrator access controls for model selection, customization, and data privacy.

A social platform for educator collaboration. Where they can share their prompts, buttons, workflow, and URLs to be reused by other teachers.

The inventive system transforms education by harnessing AI to create personalized, high-quality learning experiences while reducing educators' workloads.

### BRIEF DESCRIPTION OF DRAWINGS

FIG. 1a describes the sequence diagram on when the admin logs into the EZDucate platform, FIG. 1b describes the flow diagram of what happens when the admin logs into EZDucate platform, FIG. 1c is the UI where the Admin can choose the country, state, district, student and other relevant information as described in the claims, finally FIG. 1d is a response from the backend service after it successfully downloaded data from Virginia FCPS educational standards website according to the grade input by the administrator.

FIG. 2a describes the flow of the background process when a user (ie: Teacher) logins to the language and art module.

FIG. 3a describes the flow diagram of the background process when a user (ie: Teacher) logins to the mathematics module.

FIG. 4a describes the flow diagram of the background process when a user (ie: Teacher) logins to the flash card module.

FIG. 5a describes the smart IEP reader flow diagram and algorithm on how it extracts data about the student and processes them to be stored and used by other modules described above.

FIG. 5b shows how the smart IEP reader analyzes an uploaded document and gives recommendations.

FIG. 5c shows how the smart IEP reader parses the IEP PDF in the background process and extract texts that will be used by the LLMs.

FIG. 6a describes the workflow diagram and algorithm of the smart content generator.

FIG. 6b, FIG. 6c, and FIG. 6d show examples of how the smart content generator engine produces flashcards containing static image, videos, and 3D animation using JavaScript and Babylon JS library.

FIG. 6e, FIG. 6f, FIG. 6g, FIG. 6h, FIG. 6i, and FIG. 6j depict how users (ie: mathematics teacher can use the smart content generation to create quizzes, solve word problems, create lesson plans, visual aids, and other custom requests that help in mathematics education.

FIG. 6k, FIG. 6l, FIG. 6m, FIG. 6n, FIG. 6o depict how users (ie: language and art teachers can use the smart content generation to create quizzes, summarize text, answer questions about a text, show linear array, word maps, synonyms and antonyms, word axis and custom request for example formatting a text by using emojis and highlighting verbs and adverbs. The custom request module can allow teachers to be creative and generate many different types of interactive content.

FIG. 7a describes a backend process where the user can upload an image and the AI will automatically retrieve data about the image using OCR to capture any text in the images, CNN Networks, and Image Transformer networks to capture data about the image for example: The image depicts a fishing boat in the sea with 3 fishermen on board, working during early morning. This captured metadata will be stored and can be used by the other 3 modules: Flashcards, Mathematics, and Language and arts.

FIG. 8a describes a process that leverages the smart content generation to combine generated stories from LLM based on saved configuration parameters and generates images to illustrate the story. It is basically a visual storyteller that can be used to create content for school based on individual student level and the requirements of the school authorities (district, state, country and so on.).

FIG. 9a depicts the workflow for the process that is run when the administrator sets up what AI models to use for each module. FIG. 9b shows the UI in the application that runs the process described in FIG. 9a.

FIG. 10a describes the working of a platform to share saved generated content in an educational social media platform where teachers can exchange workflows, prompts, buttons, quizzes, flashcards, and they can be used by individual students.

FIG. 11a describes that all generated content in the platform has a share and save button and describes the workflow of what happens when we click these buttons, it also allows the users to specify the temperature parameters so we can reproduce the same content and not rely on total randomness' in the generative AI models. FIG. 11b shows examples of these share and save buttons throughout different parts of the application.

### DATA PRIVACY

### Introduction

Ensuring data privacy is at the forefront of our platform's design and implementation. We are acutely aware of the various national and international data protection regulations and have taken measures to ensure compliance, particularly when handling sensitive student and educational data.

### FERPA:

As a primary consideration, our platform has been designed in strict compliance with the Family Educational Rights and Privacy Act (FERPA) of the United States. Key features in line with FERPA regulations include:

Ensuring that student education records are kept confidential and are not disclosed without parental or eligible student consent.

Provisioning tools for institutions to allow parents or eligible students to access and review their education records.

Implementing strict security measures to safeguard education records from unauthorized access or breaches.

Including mechanisms for corrections to be made to records when inaccuracies are identified.

### International Regulations:

Beyond FERPA, our system is built to cater to a global audience, considering various regional data privacy regulations:

### Canada:

### Personal Information Protection and Electronic Documents Act (PIPEDA)

PIPEDA is Canada's main data protection legislation that governs the collection, use, and disclosure of personal information by private sector organizations. It outlines the principles organizations must follow when handling personal data.

### Canadian Provincial Laws:

Several provinces, including Alberta, British Columbia, and Quebec, have their own data protection laws that are deemed “substantially similar” to PIPEDA. For educational institutions, many provinces have specific legislation related to the handling of student information.

European Union: The platform adheres to the General Data Protection Regulation (GDPR), ensuring the rights of European citizens to data privacy and protection are maintained.

Japan: In line with the Act on the Protection of Personal Information (APPI), our platform takes measures to protect personal data, ensuring clarity in data utilization purposes and implementing strict controls on data transfer.

South Korea: Our system is compliant with the Personal Information Protection Act (PIPA), ensuring rigorous data protection standards.

Singapore: Adherence to the Personal Data Protection Act (PDPA) is maintained, ensuring that data collection, usage, and disclosure practices align with Singapore's data privacy regulations.

China: In alignment with the Cybersecurity Law and the Data Protection Law, our platform ensures that personal data is processed transparently, fairly, and securely.

### Programmatic Privacy Policy Integration:

Understanding that data privacy regulations can vary even within countries and regions, our platform features a programmatic way to integrate and manage customized privacy policy files for each customer. This allows educational institutions to specify their own data handling policies, ensuring alignment with local, state, city, or institutional regulations. It offers flexibility and adaptability, ensuring that our platform remains compliant even as legislation evolves.

### CONCLUSION

In summary, our platform's architecture prioritizes data privacy at every level, ensuring that students, educators, and institutions can trust that their data is handled with the utmost care and in line with the highest standards of data protection globally.

### REFERENCES ON TECHNOLOGIES USED

The invention uses several opensource projects, techniques, and technologies for the separate parts of the process we can site HuggingFace transformers library, PyTorch, LLAMA 2, GPT NEOX, BERT and DISTILLBERT, OpenCV computer vision library, some of these are documented on the reference's sections. The LLM and Diffusion models were fine-tuned using LORA, QLORA with 4 bit and 3 bits version because of hardware constraints, but also full precision models will be provided as part of the EZDucate platform for power users, where the platform will be hosted in the cloud.

### DETAILED DESCRIPTION OF THE INVENTION

### Smart Analysis Engine:

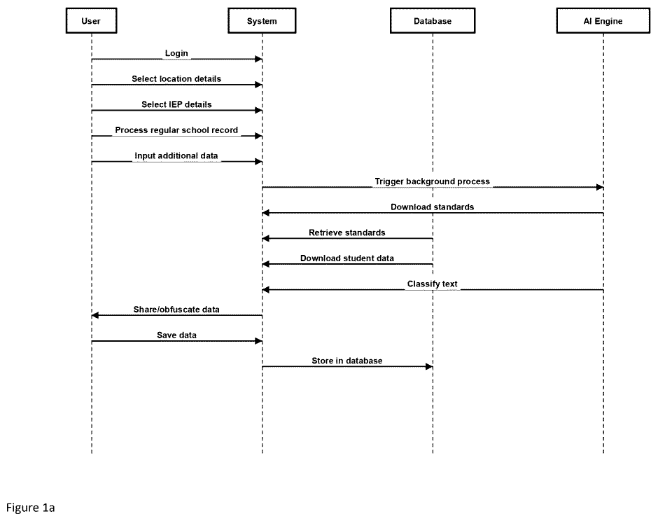

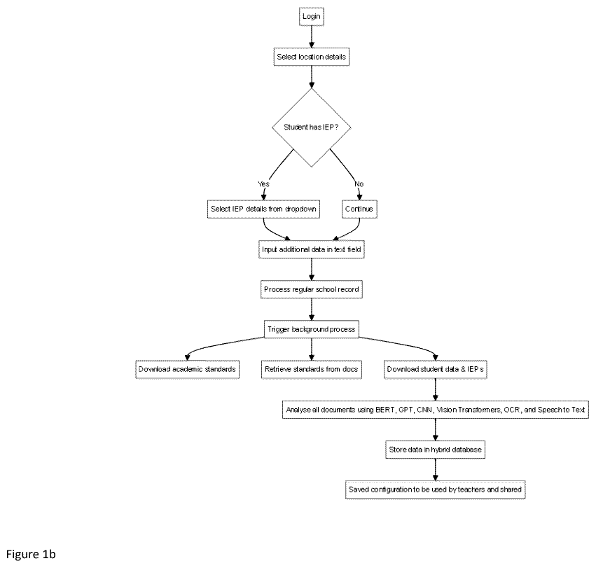

The smart analysis engine serves as the core foundation of our platform. It accepts multiple document formats, including pptx, docx, pdf, and html, from recognized academic sources. Advanced natural language processing (NLP) techniques, optimized for educational content, parse, and analyze these documents, extracting essential standards and curriculum guidelines. Furthermore, the engine is equipped to interpret Individualized Education Programs (IEPs), ensuring that the platform can cater to students with special needs. This results in highly detailed student profiles that encompass academic strengths, weaknesses, preferences, and specific requirements. These profiles are stored securely in the inventive hybrid Database engine, ensuring rapid retrieval and updates. See FIG. 1a.

### Content Generator:

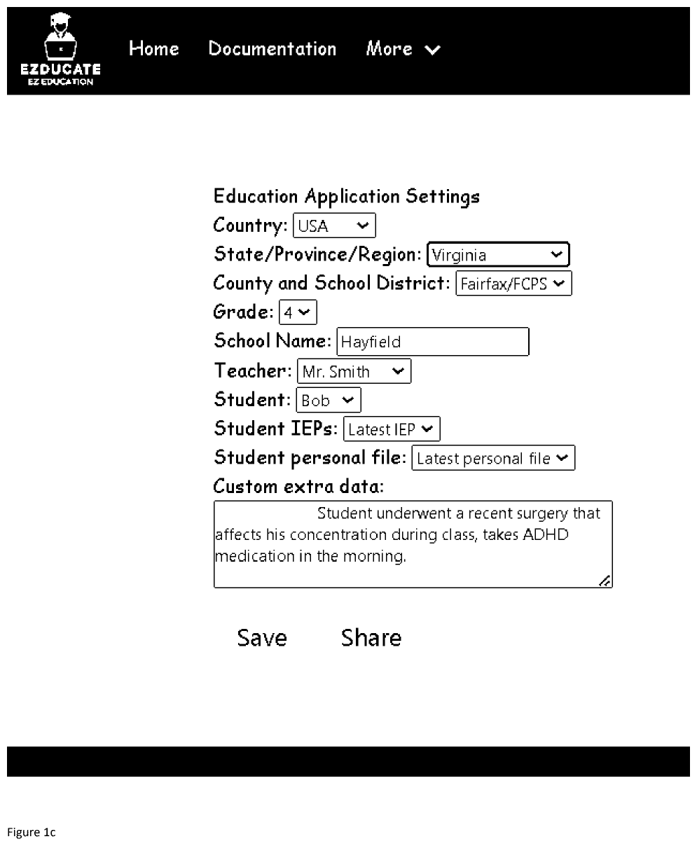

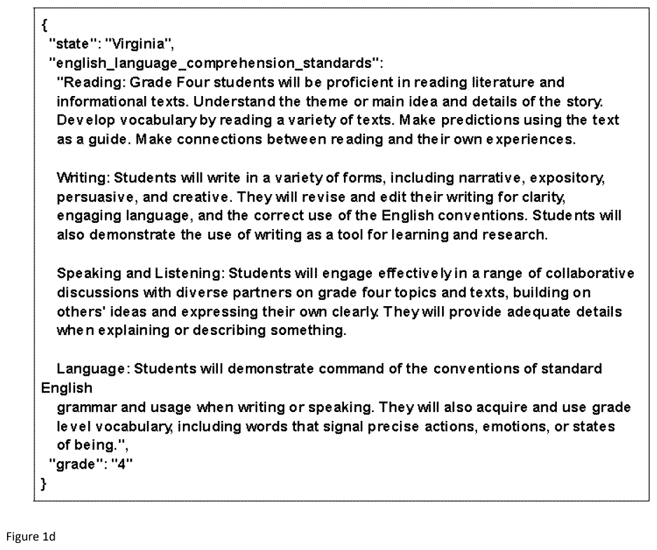

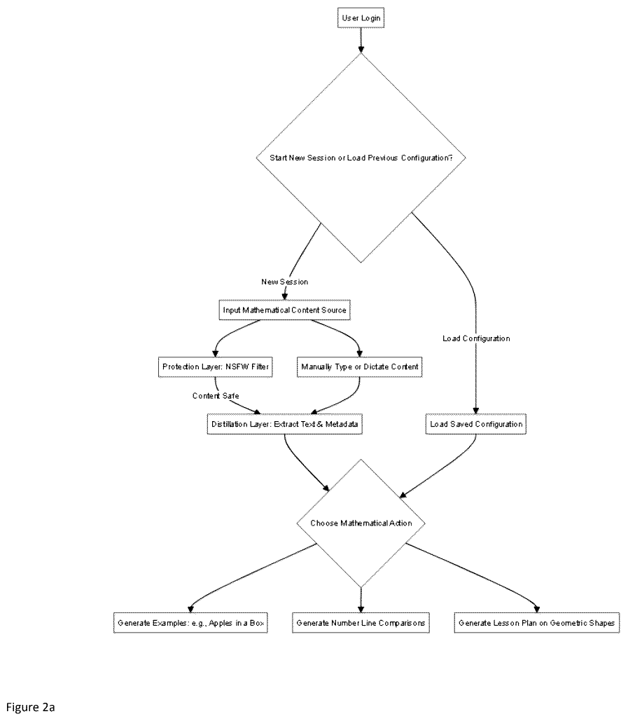

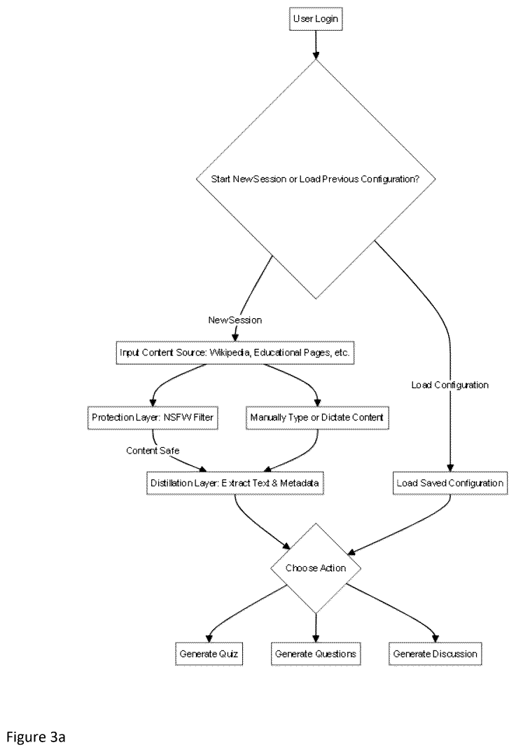

The content generator, at its heart, houses a collection of sophisticated AI models, each fine-tuned to cater to various educational needs. Leveraging the information from the student profiles, it crafts content in real-time, ensuring relevancy and personalization, FIG. 2a, FIG. 2b, FIG. 2c. Among its capabilities:

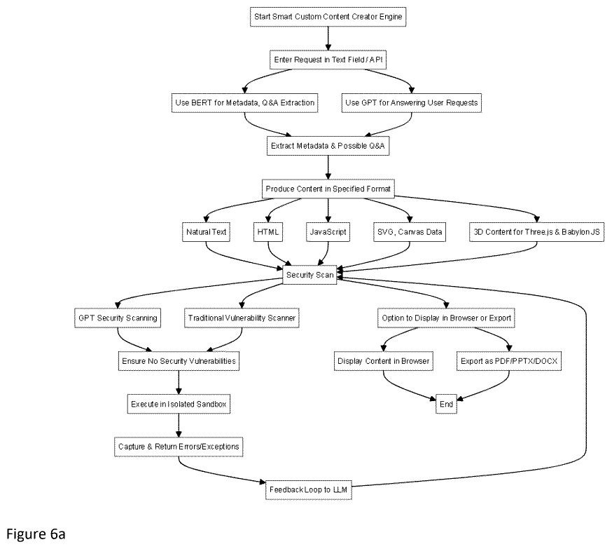

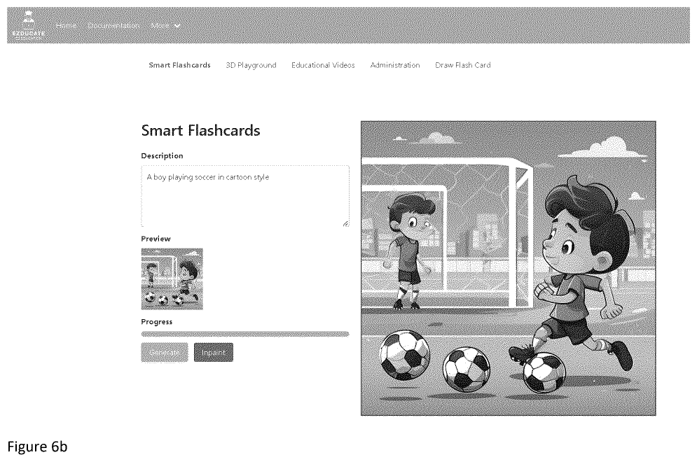

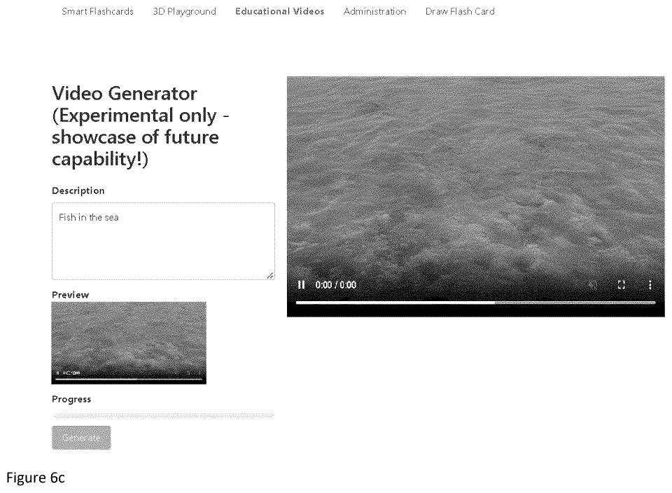

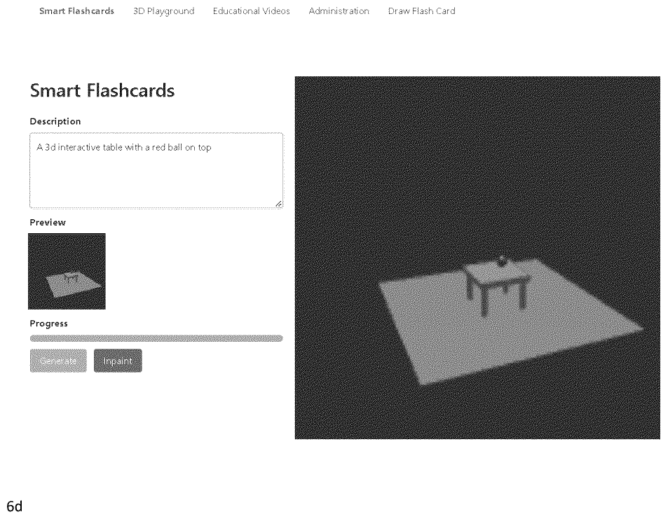

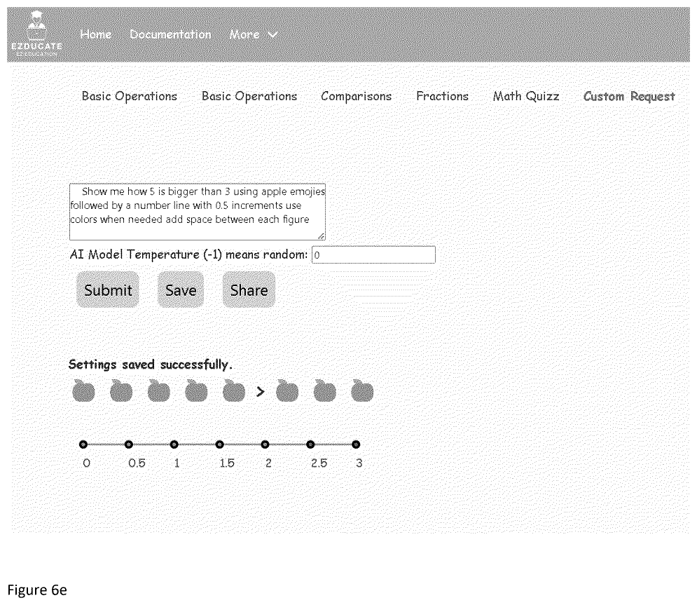

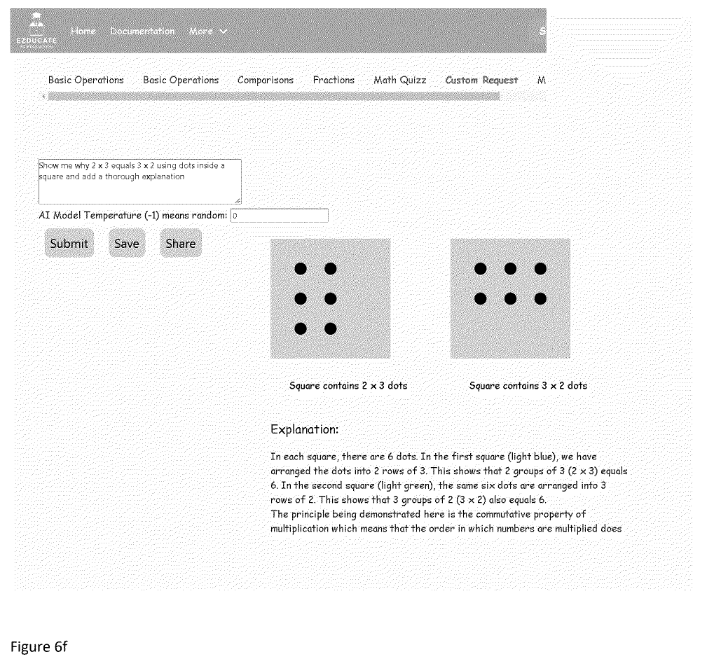

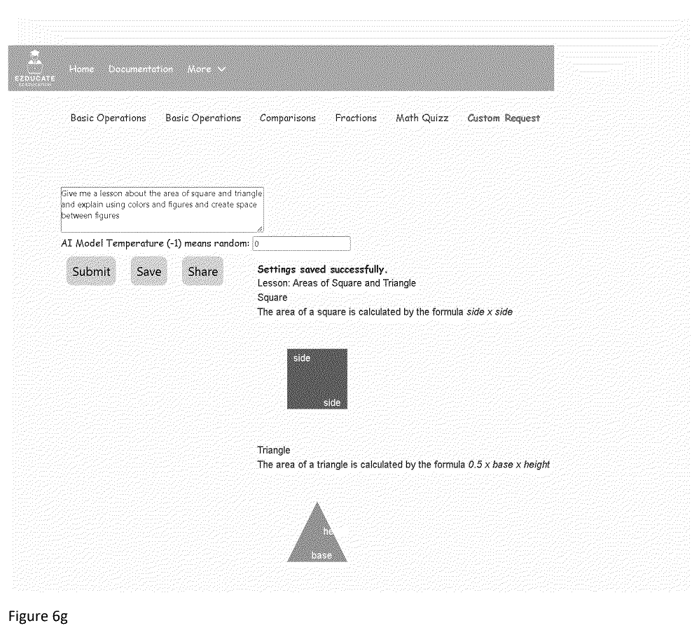

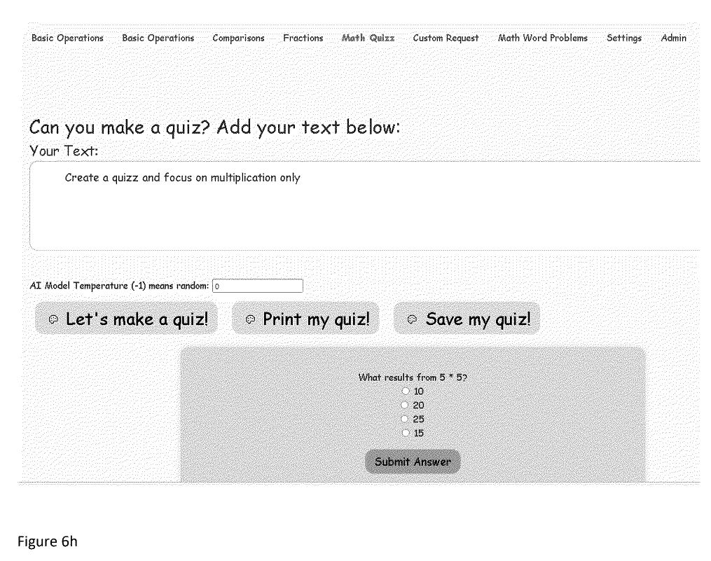

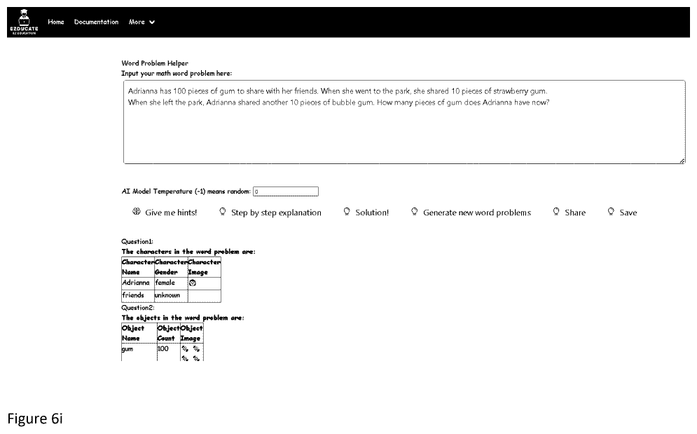

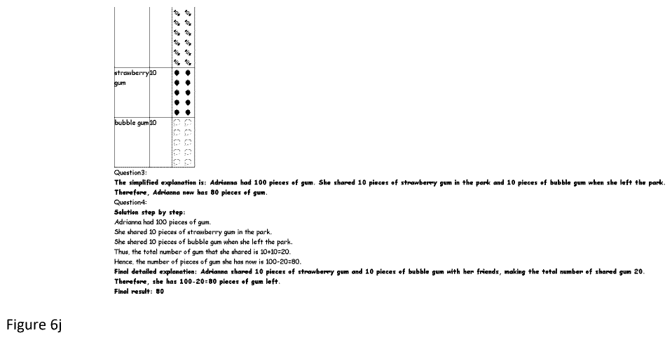

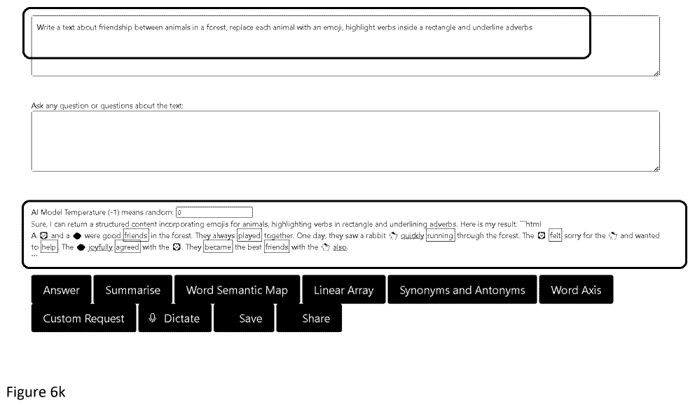

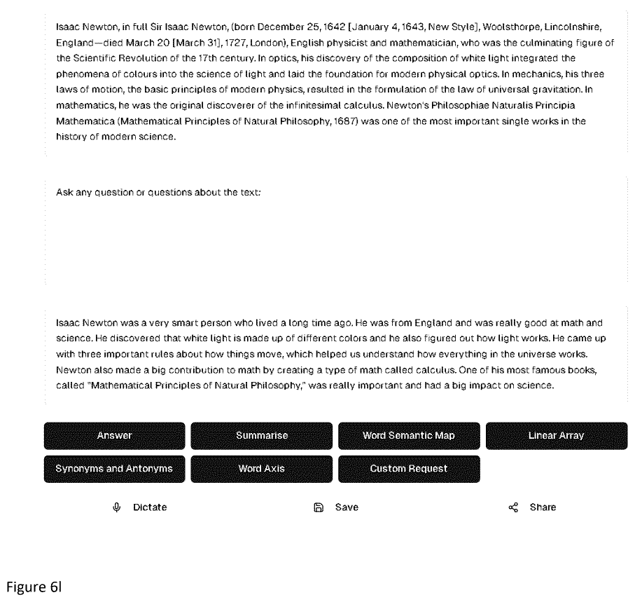

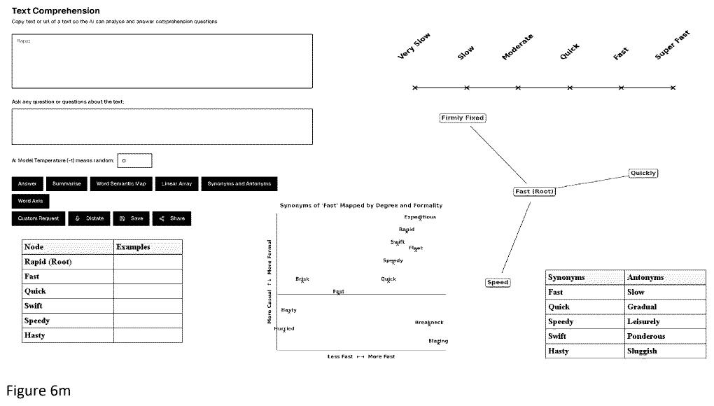

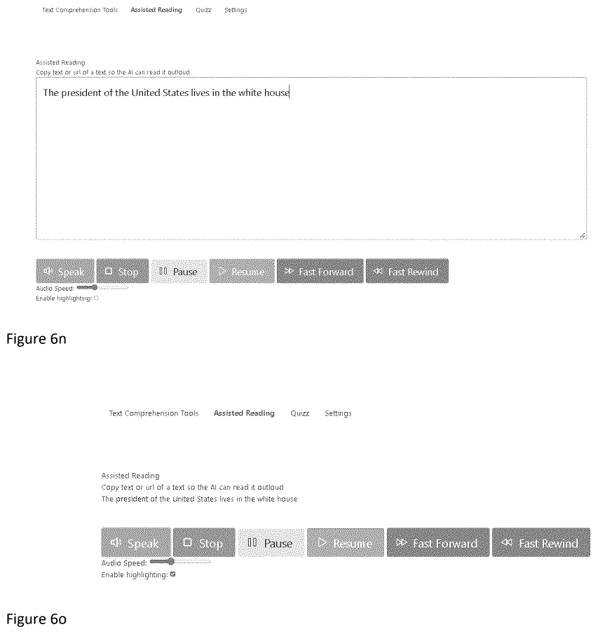

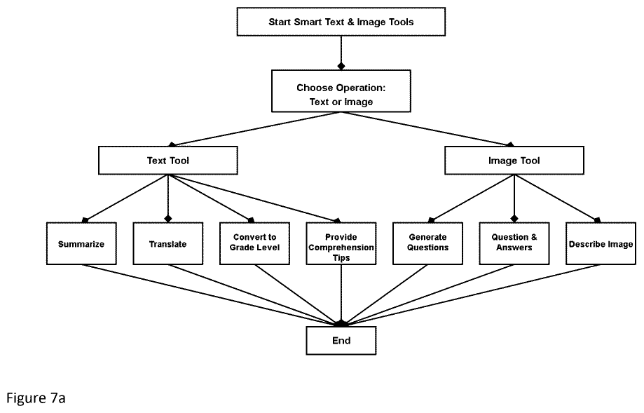

Generation of lessons, assignments, and quizzes specifically tailored to students' capabilities and requirements. FIG. 6e, FIG. 6f, FIG. 6g, FIG. 6h, FIG. 6k, FIG. 6l, FIG. 6m, FIG. 6n.

Advanced text comprehension tools that can provide real-time glossaries, phonetic pronunciation guides, and context-based explanations. FIG. 6k, FIG. 6l, FIG. 6m, FIG. 6n.

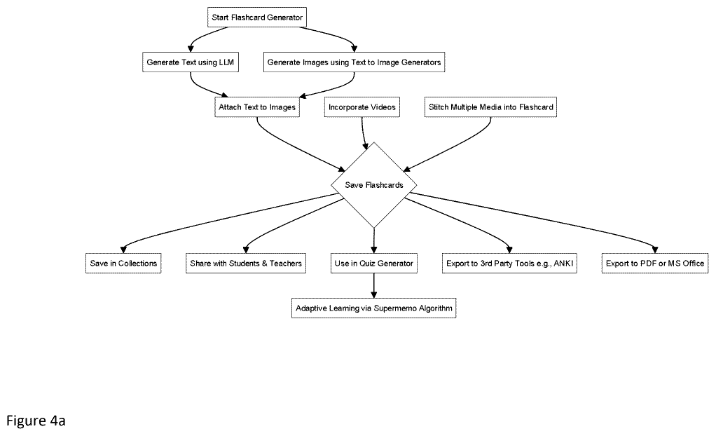

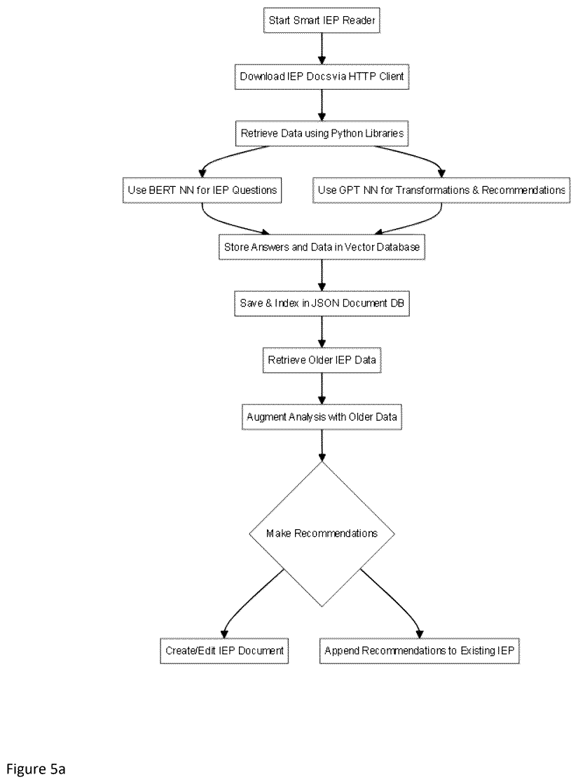

Visual aids, including dynamically generated diagrams, charts, and 3D models, cater to visual and spatial learners. FIG. 4a, FIG. 6b, FIG. 6c, and FIG. 6d.

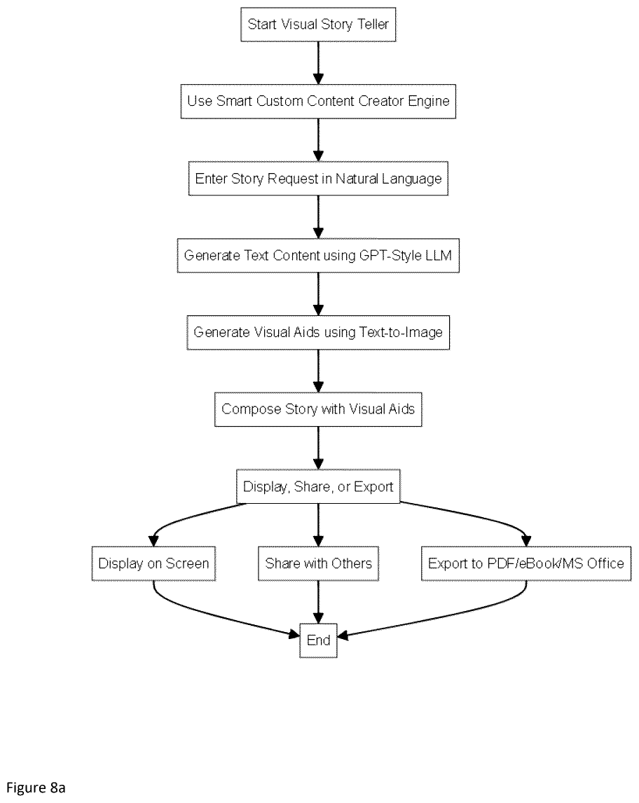

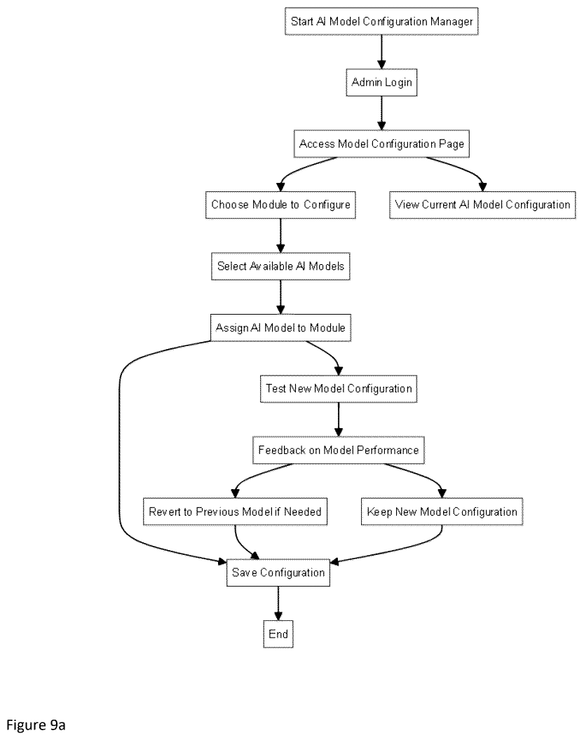

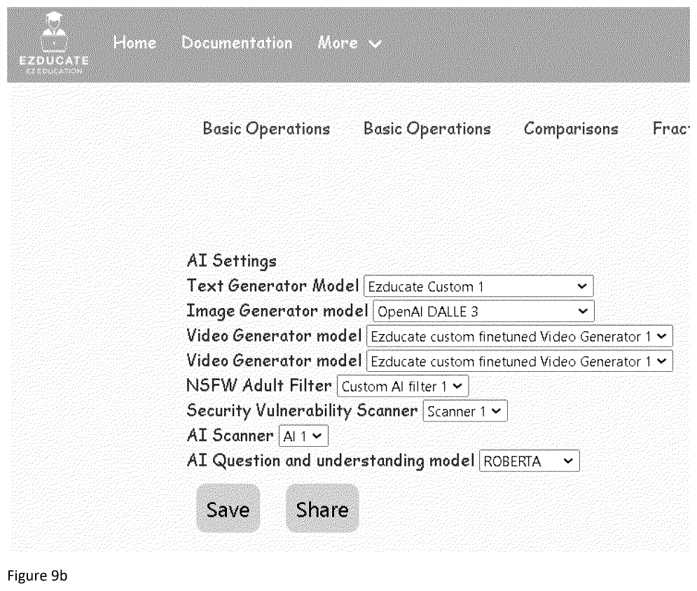

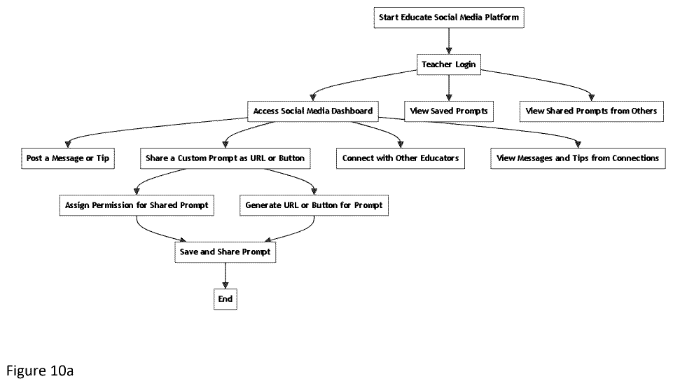

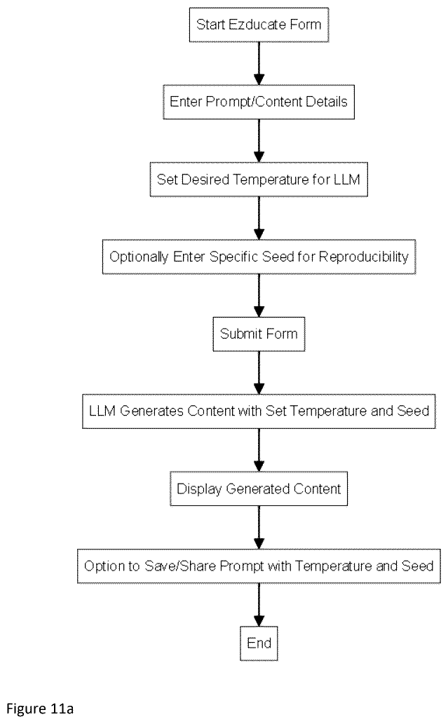

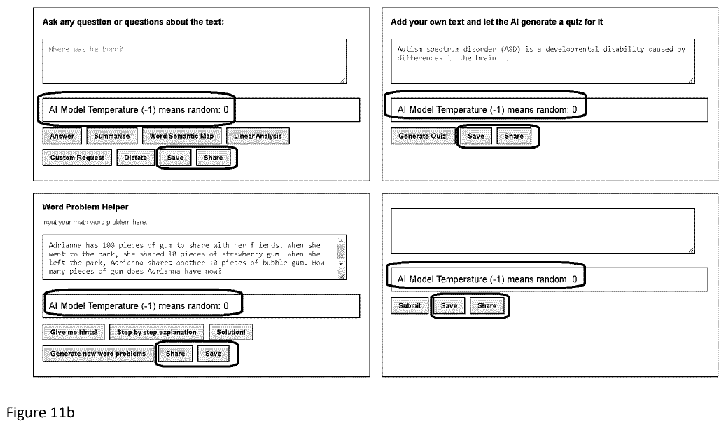

A unique feature where textual story prompts can be transformed into animated videos, providing a multi-sensory learning experience. FIG. 8a.

All content generated undergoes a quality check, powered by a feedback loop from the LLMs, ensuring educational standards are met while remaining engaging. FIG. 6a.

### Recommendation System:

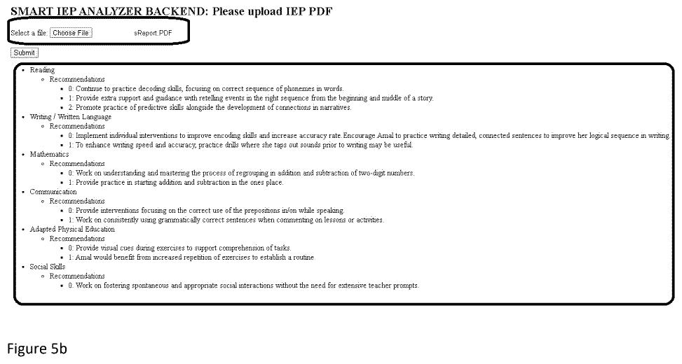

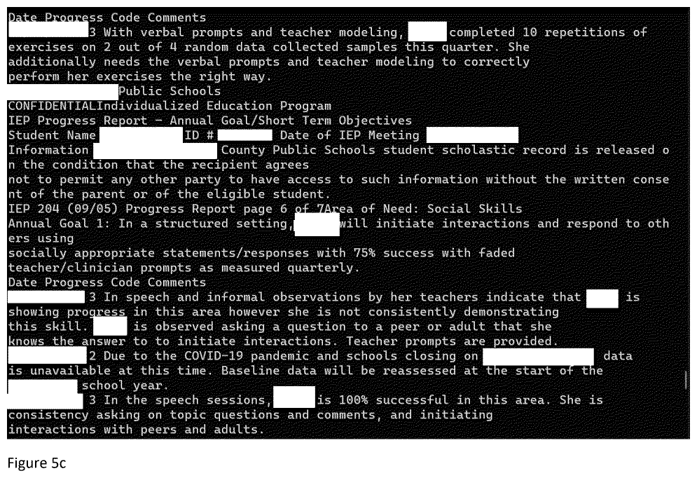

This system employs deep learning techniques to analyze the generated content in tandem with the student profiles. Based on this analysis, it provides actionable recommendations. For instance, if a student struggles with a particular concept, the system might suggest remedial lessons or alternative content forms (like videos or interactive simulations) that might resonate better. FIG. 5a, FIG. 5b, FIG. 5c.

### IEP Reader:

The IEP Reader uses advanced NLP techniques to interpret and extract essential data from IEPs. It not only understands the requirements outlined in the IEP but also suggests potential modifications or interventions to better assist educators in crafting a comprehensive educational plan for students with special needs. FIG. 5a, FIG. 5b, FIG. 5c.

### Teacher Tools:

The dashboard is designed with educators in mind. It provides a streamlined interface to review, edit, and guide auto-generated content. Through the dashboard, teachers can save specific prompts for reuse, ensuring they don't have to start from scratch every time. The inclusion of a social platform promotes collaborative efforts, allowing educators to share strategies, prompts, and feedback.

### Hybrid Database Engine:

Our proprietary database system combines the benefits of document-based storage with vector databases. Storing data in JSON format allows for flexible, schema-less data management, speeding up development and modifications. The vector database integration facilitates advanced queries based on content similarity, catering to various modalities, including text, image, sound, and more.

### REFERENCES

Dettmers, T., Pagnoni, A., Holtzman, A., & Zettlemoyer, L. (2023). Qlora: Efficient finetuning of quantized Ilms. arXiv preprint arXiv: 2305.14314.
Nguyen, T. T., Wilson, C., & Dalins, J. (2023). Fine-tuning llama 2 large language models for detecting online sexual predatory chats and abusive texts. arXiv preprint arXiv: 2308.14683.
Zhang, T., Wu, F., Katiyar, A., Weinberger, K. Q., & Artzi, Y. (2020). Revisiting few-sample BERT fine-tuning. arXiv preprint arXiv: 2006.05987.
Wolf, T., Debut, L, Sanh, V., Chaumond, J., Delangue, C., Moi, A., . . . & Rush, A. M. (2019). Huggingface's transformers: State-of-the-art natural language processing. arXiv preprint arXiv: 1910.03771.
Bradski, G., & Kaehler, A. (2000). OpenCV. Dr. Dobb's journal of software tools, 3 (2).
Imambi, S., Prakash, K. B., & Kanagachidambaresan, G. R. (2021). PyTorch. Programming with TensorFlow: Solution for Edge Computing Applications, 87-104.

1. A system comprising: an analysis engine configured to process student data including IEPs and curriculum guidelines to generate student profiles; a content generation engine configured to utilize natural language AI models to dynamically generate personalized lessons and assignments based on the student profiles; a recommendation system configured to suggest personalized learning interventions based on the generated content; a teacher interface configured to enable educator interaction with the system. A smart generative engine is able to generate different types of media based on teachers personalized request, this includes but not limited to images, videos, html, JSON, canvas 2D and 3D interactive content, custom transformation on text. All generated content can be saved or shared. All generated content is subject to vulnerability scans and is run on a secure sandbox before being released.

2. The system of claim 1, further comprising a social platform for educator collaboration.

3. The system of claim 1, wherein the content generation engine leverages pre-trained language models fine-tuned on educational data such as assignments, quizzes, word problems, mathematical reasoning.

4. The system of claim 1, further comprising an IEP analysis system configured to extract information from IEP documents and generate IEP recommendations using natural language processing.

5. The system of claim 1, further comprising administrator controls to select AI models, set access permissions, and enable customization.

6. The system of claim 1, wherein the content generation engine is configured to generate visual aids including interactive 3D concepts and videos generated from story texts.

7. The system of claim 1, wherein the content generation engine is configured to provide text comprehension tools comprising summarization, translation, text leveling, and comprehension aid features.

8. The system of claim 1, further comprising a flashcard generation system configured to generate custom flashcards with text and associated images, videos, interactive 3D content.

9. The system of claim 8, wherein the flashcard generation system includes features for sharing flashcard sets, exporting flashcards, and generating quizzes.

10. The system of claim 1, further comprising a mathematics education module configured to generate visual mathematics aids comprising mathematical concept illustrations, number lines, and geometric drawings tailored to individual students.

11. The system of claim 1, further comprising a visual storytelling module configured to generate visual stories with illustrations and associated text.

12. The system of claim 1, wherein the content generation engine leverages generative adversarial networks for image generation.

13. The system of claim 1, further comprising a model management interface to select AI models to power the various system modules.

14. The system of claim 1, further comprising a social platform for educator collaboration and sharing of content generation prompts.

15. The system of claim 1, wherein the system is compatible with legal requirements related to student data privacy and security.
